(19) United States
(12) Patent Application Publication
(10) Pub. No.: US 2002/0073027 A1
(43) Pub. Date: Jun. 13, 2002

(54) Mobile payment system

(76) Inventors: Helen Shan-Shan Hui, Hong Kong (CN); Terence Wing-Cheong Ho, Hong Kong (CN); Charlie Qing Yang, Rancho Palos Verdes, CA (US)

Correspondence Address: Raymond Yat Chiu Chan, 1050 Oakdale Lane, Arcadia, CA, 91006, US

(21) Appl. No.: 09/733,409

(22) Filed: Dec. 11, 2000

(51) Int. Cl. G06F 17/60

(52) U.S. Cl. 705/40; 705/39

(57) ABSTRACT

A mobile payment method designed to facilitate payment and transaction in addition to credit card and debit card, which includes the steps of (a) receiving a payment request in an operation center from a registered merchant through a communication network; (b) requesting the registered merchant, through the communication network, to inform a customer ID of a customer, who is a registered member of the operation center, and a transaction amount to be paid by the customer to the registered merchant; (c) verifying a merchant ID of the registered merchant by the operation center; (d) confirming the payment request by the operation center by notifying the customer and requesting for verification; (e) requesting the customer to verify the payment transaction by confirming the transaction amount and inputting a security password of the customer registered in the operation center; and (f) confirming with the registered merchant whether the payment request is issued.

### BACKGROUND OF THE INVENTION

1. Field of Invention

The present invention relates to a remote, secured, prompt and accurate payment system, and more particularly to a mobile payment system and method thereof, wherein the customer's payment is verified by sending confirmation back to the customer's device, so as to prevent passing any personal confidential information such as credit card numbers, customer's name and signature to the merchant.

2. Description of Related Arts

Traditionally, consumers could choose to settle the bill or payment by cash, checks, or credit cards. Nowadays, credit cards and credit card payment systems play a very important role in commerce. Almost everyone has at least one credit card for the necessarily of the daily life. Some people may even have more than one credit card. The use of credit cards provides an easy and convenience channel for customers to purchase. However, the crimes of forged credit cards are increasing due to rapid growth of technologies. It is very easy for slickers to forge a credit card, as they have chance to hold a credit card physically for a short period of time. So long as they have the credit card number, the name printed on the card and the expiration date, they can make up one within a very short period of time. Every year, credit cards issuing banks, merchants and credit card users worldwide are suffering tremendous financial loses because of the fraudulent counterfeited credit cards. The more people use the credit cards, the higher risk for the credit cards issuing banks to suffer losses.

Meanwhile, although the conventional credit card payment systems require an encoded terminal and a magnetic card reader. However, it does not prevent the fraudulent activities. It is very easy for slickers to forge a credit card with a magnetic encode type which is perfectly match with the original authentic one. Although the merchant may require the credit card user to provide personal identification for further security, most of the merchants are not willing to ask the customer to provide personal identification because nobody would like to disclose his or her personal information such as name, credit card number and signature to a unfamiliar merchant. Moreover, the majority of the customers may feel offended by such request. In order to provide better customers' services and remain competitive, merchants are taking risks of financial loses in their daily businesses.

In the conventional credit card payment systems, as shown in FIG. 1, the payment transaction must be confirmed by the bank, wherein a confirmation of transaction (after verification) is sent from the verifying agent (the bank) to the verification-seeking agent (the merchant).

The conventional credit card terminals are endangering the credit card owners' security. Under the current conventional credit card payment system, a printed receipt containing the credit card number, expiration date of the credit card, the name of the consumer, and the signature of the customer must be provided in every transaction. Since such credit card receipt contains all the important credit card information of the customer, it will be a moral hazard for the customer if such information is abused or misplaced by the merchant. The customer's sensitive information such as signature may be accidentally exposed authorized person who may forge the signature. Even in the debit system such as EPS, the password is keyed in the merchant's terminal, thereby theoretically the merchant could save the password.

In certain extents, carrying the credit card is sort of inconvenient. People always put their credit cards inside their wallets or purses. If they have forgotten to bring along with their wallets or purses with them as they are going out, they cannot purchase anything. It is because the conventional credit card payment systems require the physical appearance of the subject credit card in order to complete a duly transaction. Due to the limitation of the conventional credit card payment system, it fails to provide any alternative to the credit card holder and merchant in regard to the security and safety. Without the physical credit card, even though the cardholder remembers the credit card number and its expiration date, no merchant will let the customer to purchase anything at all.

In addition, since the conventional credit card payment systems require the merchant to do a closing procedure after every business day in order to obtain the funds from the bank, if the merchant is mistaken the transaction amount, the credit card owner may not discover until he or she receives a printed statement twenty to thirty days later. It will be a great burden for the credit card owner to recover the excess payment.

Besides, with the recent rise of information technology, e-commerce is gaining its momentum as a new way of handling transaction. However, e-commerce is restricted to fixed-line terminals and computers connecting to the Internet. The customers are still required to authorize the e-commercial merchant to charge their credit card or checking account in order to purchase goods through Internet. Therefore, the customers are unavoidably required to disclose their personal confidential information for any purchase.

### SUMMARY OF THE PRESENT INVENTION

It is a main object of the present invention to provide a mobile payment system and method thereof, wherein the customer's payment is verified by sending confirmation back to the customer's device, so as to prevent passing any personal confidential information such as credit card numbers, customer's name and signature to the merchant.

It is another object of the present invention can also provide a mobile payment system and method thereof, which provides a customer-oriented verification that enables the customer to receive the transaction details back from the bank, initiate the confirmation process, without passing any personal and/or confidential information to the merchant. The customer may just pass a security code which can be changed from time to time upon mutual agreement between the customer and the bank.

It is another object of the present invention to provide a mobile payment system and method thereof, which is designed to facilitate a new means of payment and transaction in addition to EPS or VISA.

It is another object of the present invention to provide a mobile payment system and method thereof, wherein end users could choose to settle the bill or payment by mobile devices such as WAP phone, that the payment amount can be debited directly on the end user's mobile account. The targeted end users can be the general public and the involved parties to complete the transaction flow are the shops, cellular operator(s) and/or banks.

It is another object of the present invention to provide a mobile payment system and method thereof, which is a remote, secured, prompt and accurate payment system by using a communication device and a communication network without requiring the customer to present any credit card while can still confirming the identification of the customer.

It is another object of the present invention to provide a mobile payment system and method thereof, wherein the merchant and the customer can transact purchase without the limitation of the presence of the credit card and eliminate the inconvenient of such limitation.

In order to accomplish the above objects, the present invention provides a mobile payment method, which comprises the steps of:

(a) receiving a payment request in an operation center from a registered merchant through a communication network;

(b) requesting the registered merchant, through the communication network, to inform a customer ID of a customer, who is a registered member of the operation center, and a transaction amount to be paid by the customer to the registered merchant;

(c) verifying a merchant ID of the registered merchant by the operation center;

(d) confirming the payment request by the operation center by notifying the customer and requesting for verification;

(e) requesting the customer to verify the payment transaction by confirming the transaction amount and inputting a security password of the customer registered in the operation center; and

(f) confirming with the registered merchant whether the payment request is issued.

### BRIEF DESCRIPTION OF THE DRAWINGS

FIG. 1 is a block diagram illustrating the procedures of credit card payment through the conventional credit card payment system by the conventional terminal.

FIG. 2 is a block diagram illustrating a mobile payment method according to a preferred embodiment of the present invention.

FIG. 3 is a schematic diagram illustrating the mobile payment system and method thereof according to the above preferred embodiment of the present invention.

### DETAILED DESCRIPTION OF THE PREFERRED EMBODIMENTS

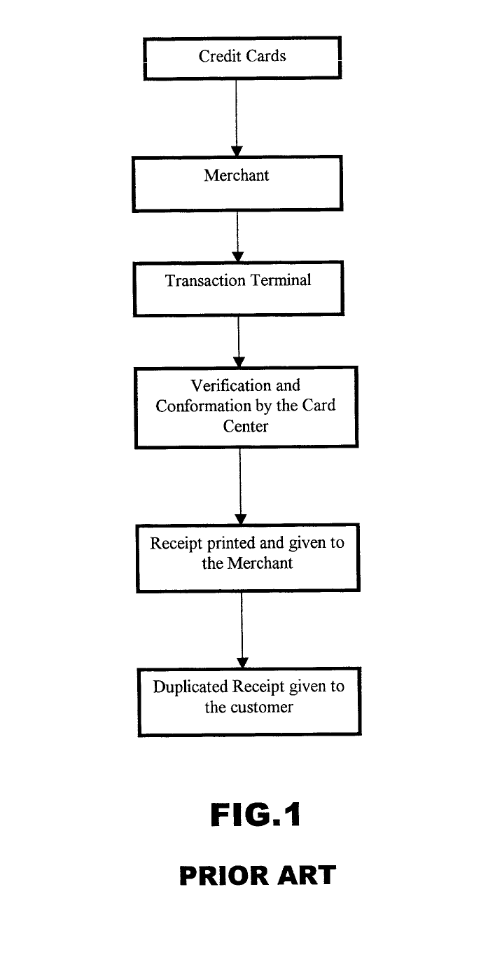

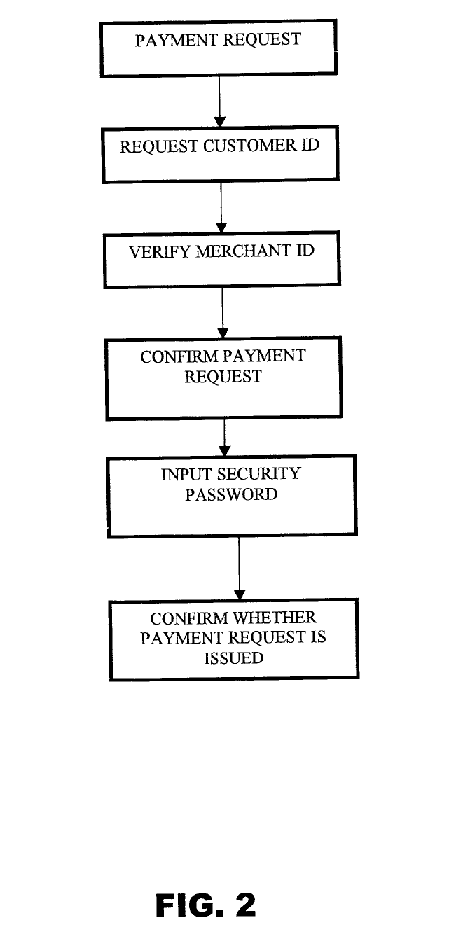

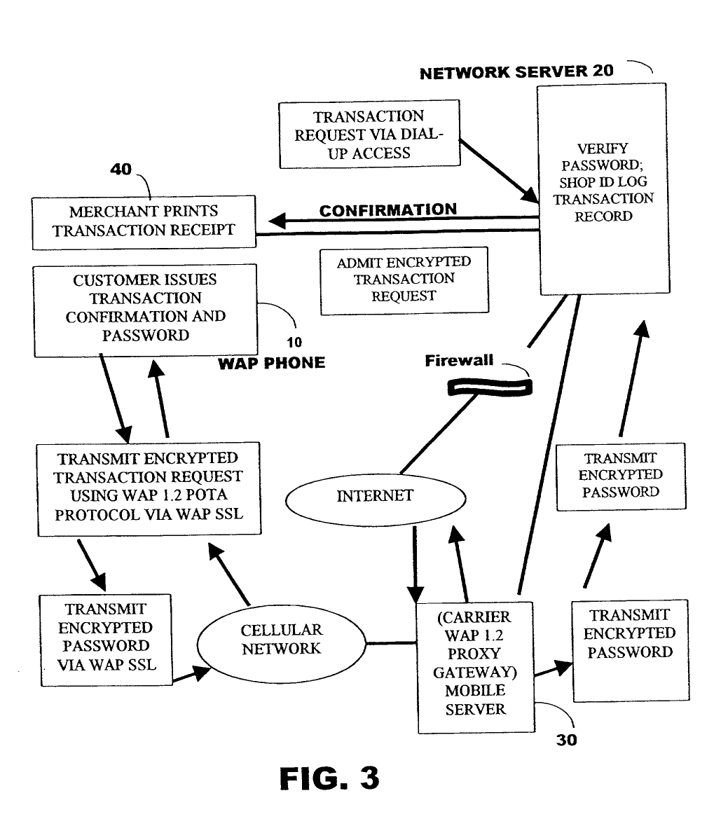

Referring to FIGS. 1 to 4, a mobile payment method according to a preferred embodiment of the present invention is illustrated, which comprises the following steps.

(a) Receive a payment request in an operation center from a registered merchant through a communication network.

(b) Request the registered merchant, through the communication network, to inform a customer ID of a customer, who is a registered member of the operation center, and a transaction amount to be paid by the customer to the registered merchant.

(c) Verify a merchant ID of the registered merchant by the operation center.

(d) Confirm the payment request by the operation center by notifying the customer and requesting for verification.

(e) Request the customer to verify the payment transaction by confirming the transaction amount and inputting a security password of the customer registered in the operation center.

(f) Confirm with the registered merchant whether the payment request is issued.

Nowadays, cellular phones are one of the necessities of our daily life. Regardless the age and the income level, almost every individual has a cellular phone. The creation of cellular phone eliminates the limitation of communication among people. It brings not only people much more closer than before but also brings the speed and convenience that human beings so much deserved. Due to the innovations of the technologies of cellular communication, the sizes and the weight of cellular phones are much more compact and lighter than the way it was years ago. People now are carrying their cellular phones wherever they go because of the compact of the sizes and the convenience that the cellular phones can offer.

Wireless data is definitely the future trend in the coming few years. For example, we are going to have 2.5 G systems like GPRS to replace GSM to support higher speed wireless data connection and packet data service. By the end of year 2001, we shall have 3G wireless systems supporting up to 2 Mbps-transmission rate. All these show that wireless transmission is getting faster and faster and mobile devices will be more and more powerful. Therefore, M-commerce is going to be a new way of living.

Also, the usage of the cellular phone nowadays is not only limited on the voice communication but also by the WAP (Wireless Application Protocol) technologies, it provides graphic and text communication via the internet to its users. Currently, people can surf the Internet, trade stocks and even transact banking activities by using a cellular phone with WAP capability. Cellular phone with the WAP capability currently is virtually the most useful and smallest personal communication device can be found and affordable in the marketplace. It is because of its affordability, using such kind of cellular phone has become a trend.

Therefore, a cellular phone with WAP (Wireless Application Protocol) capability is embodied, according to the preferred embodiment of the present invention, for transaction communication. In other words, the communication network as recited in step (a) is a WAP secured transaction layer cellular network.

Besides, it is well known that the credit card is only an identification of a credit account assigned by a bank to the credit card member. Also, the debit card and ATM card are identification of a bank account of the customer. In other words, the number on the credit card, debit card or ATM card is an ID code of the customer's account. Accordingly, the operation center can be the card center of a payment system such as the credit card system, the debit card system or even the ATM card system of a specific bank. The customer is an effective account owner of a specific payment system. The merchants should be pre-registered in the operation center of the payment system as registered merchant so that they are qualified to request payment for their customers. Generally, each registered merchant can be assigned with a merchant ID code. The customer ID can be a credit code, a debit code, or a bank account number of the customer with respect to the payment system.

According to the preferred embodiment, since a WAP phone is used as a communication device 10 to contact with the operation center, which comprises a network server 20 for receiving the payment request from the registered merchant in the step (a) and a mobile server 30 for confirmation of the payment with the customer in the steps (d) and (e). The customer ID can simply be the WAP phone number of the customer and the registered merchant can connect with the operation center through a regular PSTN dialup telephone line, an ISDN line, a leased line, or a broadband line.

According to the preferred embodiment of the present invention, before the step (a) further comprises the steps of:

indicating to the registered merchant by the customer that the customer prefers to settle a payment through a mobile payment system when the customer decides to purchase a particular product from the registered merchant; and

initialing transaction by sending the payment request to the operation center by the registered merchant through a communication terminal 40 such as a dial-up telephone line.

The step (b) further comprises the steps of:

(b.1) requesting the customer ID (i.e. the WAP phone number according to the present preferred embodiment) of the customer and the transaction amount by the operation center through the communication terminal 40; and

(b.2) entering the customer ID of the customer and the transaction amount to be paid by the customer to the registered merchant through the communication terminal 40.

The communication terminal 40 can be a cellular phone, a device with a modem and an indicator screen which support the graphic and text information, a device with abilities to transfer a voice sequences into a graphic and text information, and terminal installed by the said payment system, or, a conventional credit card payment terminal, which connected with the common network of the said payment system by PSTN dial up telephone line, or an ISDN line, a leased line or a broadband line.

In the step (b), further transaction information may be requested by the operation center, i.e. the purchased product, transaction date and time, and the merchant's name and his physical location.

The step (c) further comprises the steps of:

(c.1) receiving the customer ID and the transaction amount from the registered merchant by the operation center;

(c.2) verifying identity of the registered merchant by checking a merchant database by the operation center; and

(c.3) pushing a transaction request to the communication device (i.e. the WAP phone) of the customer using WAP 1.2 push architecture when the identity of the registered merchant is valid and the transaction amount does not excess the payable limit of customer's account.

The step (d) further comprises the steps of:

(d.1) sending a notification message to the communication device of the customer to indicate the payment request; and

(d.2) verifying the transaction amount and other transaction information with customer.

The step (e) further comprises the steps of:

(e.1) requesting the customer to confirm the transaction amount and to enter the security password of the customer;

(e.2) verifying the transaction amount and inputting the security password by the customer;

(e.3) transmitting the security password and confirmation to the mobile server 30 over the air by using WAP 1.2 secured transaction layer through the cellular network;

(e.4) forwarding the security password and confirmation to the network server 20 via an Internet using IPSec protocol;

(e.5) scrutinizing the security password and confirmation by a firewall of the network server 20 to make sure the security password and confirmation are authenticate; and

(e.6) verifying the security password of the customer by the network server 20 of the operation center by checking the customer database thereof.

In the step (e.6), depending on the credit risk bearing arrangement, the security password checking and credit validation may be done by the credit bearer such as the telecom operator or a financial institution.

The step (f) further comprises the steps of:

(f.1) issuing a final transaction confirmation the successful verification in the step (e) to the registered merchant's communication terminal 40 via the dial-up telephone line; and

(f.2) printing a transaction receipt by the communication terminal 40 to complete the payment transaction.

In the step (f.2), there will be a hard copy of the transaction receipt to be retained by both the registered merchant and the customer for verification. The payment information will also be logged in the network server for double audit.

In view of above, it is apparent that a main feature of the present invention is the sending of the confirmation back to the customer's communication device, i.e. “customer-oriented verification”. However, in the conventional payment systems, the confirmation of transaction after verification is sent from the “verifying agent”, i.e. bank, to the “verification-seeking agent”, i.e. merchant.

The customer-oriented verification is for the customer, who receives the transaction details back form the bank, initiate the confirmation process, without passing any sensitive information to the merchant, including credit card number, expiration date, card holder's name, and signature of the card holder. The customer just passes a security password which can be changed from time to time upon mutual agreement between the customer and the bank. It should notice that the security password does not necessarily need to be the phone number directly, but rather some code that can allow the bank to identify the customer, find out his or her phone number and call him or her.

The targeted end users of the mobile payment system of the present invention will be the general public and the involved parties to complete the transaction flow are the shops, cellular operator(s) and/or banks. End users could choose to settle the bill or payment by mobile server 30 (such as WAP phones) using the present mobile payment system protocol. The payment amount can also be debited directly on the customer's mobile account. Mobile operators can settle the monthly revenue with individual shops. Depending on the security level of the mobile payment system protocol, there will be an adjustable credit amount for individual customers.

At the lowest security of the mobile payment system and method, the credit amount can be limited to small transactions only and the risk of fraudulent transaction is minimized. The mobile payment method is designed to support a scalable transaction security level. As the security level increases, the credit amount will be increased as well. The mobile operators as well as banks could share the credit risk.

Basically, the mobile payment method is divided into two parts, i.e. the front-end transaction engine, FETE, and the back-end billing engine, BEBE, the FETE is designed to handle the real-time transaction between the customer holding a communication device 10 and the registered merchant installed with the communication terminal 40. It ensures a low cost, efficient and secured two-way M-commerce transaction. The FETE system consists of the low cost communication terminal 40 (installed in a merchant), a software process at the network server 20 as well as the mobile payment system to complete the payment transaction. For easy penetration into general merchants such as retail shops, the mobile payment system simply requires a PSTN telephone line at the shop and this reduces the deployment cost. On the other hand, the BEBE is a software system at the network server 20 responsible for the billing information management of various shops and the cross auditing of revenue between the operation center and the registered merchant. It is designed to handle and verify the payment transaction and billing between the operators and the retail shops.

It is worth to mention that under the conception of the present invention, the product purchased by said customer can be a service and said merchant can be a service provider such as a restaurant, a doctor, a spa and etc.

The advantage of the WAP-mobile payment system and method thereof according to the present invention is simplicity and low-cost because any generic WAP phone users could use this service. There are no special hardware and software requirements in the mobile device as well and therefore, it is ideal for small amount transaction where the security risk is acceptable.

Other advantages of the present invention include the following:

(1) The customer's payment is verified by sending confirmation back to the customer's device, so as to prevent passing any personal confidential information such as credit card numbers, customer's name and signature to the merchant.

(2) It provides a customer-oriented verification that enables the customer to receive the transaction details back from the bank, initiate the confirmation process, without passing any personal and/or confidential information to the merchant. The customer may just pass a security code which can be changed from time to time upon mutual agreement between the customer and the bank.

(3) It is a remote, secured, prompt and accurate payment system by using a communication device and a communication network without requiring the customer to present any credit card while can still confirming the identification of the customer.

(4) The present invention provides the convenience that the customer can make purchase without carrying a credit card and the hassle of asking and providing personal identification. The merchant and the customer can transact purchase without the limitation of the presence of the credit card and eliminate the inconvenient of such limitation.

(5) The merchant have no chance to hold on the customer's credit card physically. It eliminates the chance for a forged credit card.

(6) The present invention prevents fraudulent activities by not having the customer to sign on a printed receipt, which contains all the material credit card information of the customer.

So long as the general public accept and use this invention, any business entities can issue their customer any credit limit as they want to and making payment as requested by their customers, thereby the monopoly sustained by the major credit card payment system will be dissolved. As a result, the consumers will not have to suffer from the high service fees and costs associated with the credit cards as they are today.

What is claimed is:

1. A mobile payment method, comprising the steps of:
(a) receiving a payment request in an operation center from a registered merchant through a communication network;
(b) requesting said registered merchant, through said communication network, to inform a customer ID of a customer, who is a registered member of said operation center, and a transaction amount to be paid by said customer to said registered merchant;
(c) verifying a merchant ID of said registered merchant by said operation center;
(d) confirming said payment request by said operation center by notifying said customer and requesting for verification;
(e) requesting said customer to verify said payment transaction by confirming said transaction amount and inputting a security password of said customer registered in said operation center; and
(f) confirming with said registered merchant whether said payment request is issued.

2. The mobile payment method, as recited in claim 1, before the step (a), further comprising the steps of:
indicating to said registered merchant by said customer that said customer prefers to settle a payment through a mobile payment system when said customer decides to purchase one or more product from said registered merchant; and
initialing transaction by sending said payment request to said operation center by said registered merchant through a communication terminal.

3. The mobile payment method, as recited in claim 1, wherein the step (b) further comprises the steps of:
(b.1) requesting said customer ID of said customer and said transaction amount by said operation center through a communication terminal; and
(b.2) entering said customer ID of said customer and said transaction amount to be paid by said customer to said registered merchant through said communication terminal.

4. The mobile payment method, as recited in claim 2, wherein the step (b) further comprises the steps of:
(b.1) requesting said customer ID of said customer and said transaction amount by said operation center through said communication terminal; and
(b.2) entering said customer ID of said customer and said transaction amount to be paid by said customer to said registered merchant through said communication terminal.

5. The mobile payment method, as recited in claim 4, wherein, in the step (b), further transaction information is requested by said operation center, wherein said transaction information include but not limit to product code, transaction date and time, and identification of said registered merchant.

6. The mobile payment method, as recited in claim 1, wherein the step (c) further comprises the steps of:
(c.1) receiving said customer ID and said transaction amount from said registered merchant by said operation center; and
(c.2) verifying identity of said registered merchant by checking a merchant database by said operation center.

7. The mobile payment method, as recited in claim 2, wherein the step (c) further comprises the steps of:
(c.1) receiving said customer ID and said transaction amount from said registered merchant by said operation center; and
(c.2) verifying identity of said registered merchant by checking a merchant database by said operation center.

8. The mobile payment method, as recited in claim 3, wherein the step (c) further comprises the steps of:
(c.1) receiving said customer ID and said transaction amount from said registered merchant by said operation center; and
(c.2) verifying identity of said registered merchant by checking a merchant database by said operation center.

9. The mobile payment method, as recited in claim 4, wherein the step (c) further comprises the steps of:
(c.1) receiving said customer ID and said transaction amount from said registered merchant by said operation center; and
(c.2) verifying identity of said registered merchant by checking a merchant database by said operation center.

10. The mobile payment method, as recited in claim 6, wherein said communication device is a WAP phone and the step (c) further comprises a step (c.3) of pushing a transaction request to said WAP phone of said customer using WAP 1.2 push architecture when said identity of said registered merchant and said transaction amount are valid.

11. The mobile payment method, as recited in claim 7, wherein said communication device is a WAP phone and the step (c) further comprises a step (c.3) of pushing a transaction request to said WAP phone of said customer using WAP 1.2 push architecture when said identity of said registered merchant and said transaction amount are valid.

12. The mobile payment method, as recited in claim 8, wherein said communication device is a WAP phone and the step (c) further comprises a step (c.3) of pushing a transaction request to said WAP phone of said customer using WAP 1.2 push architecture when said identity of said registered merchant and said transaction amount are valid.

13. The mobile payment method, as recited in claim 9, wherein said communication device is a WAP phone and the step (c) further comprises a step (c.3) of pushing a transaction request to said WAP phone of said customer using WAP 1.2 push architecture when said identity of said registered merchant and said transaction amount are valid.

14. The mobile payment method, as recited in one of claims 1, 2, 3, 4, 6, 7, 8, and 9, wherein the step (d) further comprises the steps of:
(d.1) sending a notification message to said communication device of said customer to indicate said payment request; and
(d.2) verifying said transaction amount and other transaction information with said customer.

15. The mobile payment method, as recited in claim 14, wherein the step (e) further comprises the steps of:
(e.1) requesting said customer to confirm said transaction amount and to enter said security password of said customer; and
(e.2) verifying said transaction amount and inputting said security password by said customer.

16. The mobile payment method, as recited in claim 10, 11, 12, or 13, wherein said operation center comprises a network server for receiving said payment request from said registered merchant in the step (a) and a mobile server, which communicates with said network server via an Internet, for confirmation of said payment with said customer in the steps (d) and (e), in which said network server communicates with said mobile server via an Internet, wherein the step (e) further comprises the steps of:
(e.1) requesting said customer to confirm said transaction amount and to enter said security password of said customer;
(e.2) verifying said transaction amount and inputting said security password by said customer;
(e.3) transmitting said security password and confirmation to said mobile server over said air by using WAP1.2 secured transaction layer through said cellular network;
(e.4) forwarding said security password and confirmation to said network server via an Internet using IPSec protocol;
(e.5) scrutinizing said security password and confirmation by a firewall of said network server to make sure said security password and confirmation are authenticate; and
(e.6) verifying said security password of said customer by said network server of said operation center by checking said customer database thereof.

17. The mobile payment method, as recited in claim 16, wherein the step (f) further comprises the steps of:
(f.1) issuing a final transaction confirmation a successful verification in the step (e) to said communication terminal of said registered merchant via a dial-up telephone line; and
(f.2) printing a transaction receipt by said communication terminal to complete said payment transaction.

18. The mobile payment method, as recited in claim 10, 11, 12, or 13, wherein said security password is a phone number of said WAP phone of said customer.

19. The mobile payment method, as recited in claim 16, wherein said security password is a phone number of said WAP phone of said customer.

20. The mobile payment method, as recited in claim 10, 11, 12, or 13, wherein said communication network is a WAP secured transaction layer cellular network.

21. The mobile payment method, as recited in claim 16, wherein said communication network is a WAP secured transaction layer cellular network.

22. A mobile payment system, comprising:
at least a communication terminal installed by a merchant registered in an operation center as registered merchant;
a communication network for connecting said communication terminal of said registered merchant with an operation center, wherein said registered merchant is capable of submitting a payment request to said operation center by said registered merchant at said communication terminal via said communication network, wherein after said operation center receives said payment request, said operation center is capable of requesting said registered merchant, through said communication network, to inform a customer ID of a customer, who is a registered member of said operation center, and a transaction amount to be paid by said customer to said registered merchant; and
a communication device, which is carried by said customer, connecting with said operation center for receiving confirmation message from said operation center to verify a payment amount requested by said registered merchant for at least a product purchased by said customer from said registered merchant, by entering a security password of said customer in said communication device for transmitting to said operation center.

23. The mobile payment system, as recited in claim 22, wherein said operation center comprises a network server for receiving said payment request from said registered merchant and a mobile server, which communicates with said network server via an Internet, for confirmation of said payment with said customer.

24. The mobile payment system, as recited in claim 22, wherein said communication device is a WAP phone communicating with said operation center via a cellular network.

25. The mobile payment system, as recited in claim 23, wherein said communication device is a WAP phone communicating with said mobile server via a cellular network.

26. The mobile payment system, as recited in claim 22, wherein said communication terminal is connected with said operation center through a dial-up telephone line.

27. The mobile payment system, as recited in claim 23, wherein said communication terminal is connected with said network server through a dial-up telephone line.

28. The mobile payment system, as recited in claim 24, wherein said communication terminal is connected with said operation center through a dial-up telephone line.

29. The mobile payment system, as recited in claim 25, wherein said communication terminal is connected with said network server through a dial-up telephone line.
